(19) United States
(12) Patent Application Publication
(10) Pub. No.: US 2024/0247541 A1
(43) Pub. Date: Jul. 25, 2024

(54) CIP-DISPLACEABLE WAND WITH RESTRICTOR

(71) Applicant: MAXXMAR INC., Toronto (CA)

(72) Inventor: Mario Marocco, Toronto (CA)

(73) Assignee: MAXXMAR INC, Toronto (CA)

(21) Appl. No.: 18/121,362

(22) Filed: Mar. 14, 2023

Related U.S. Application Data
(63) Continuation-in-part of application No. 18/101,488, filed on Jan. 25, 2023.

(51) Int. Cl. E06B 9/322

(52) U.S. Cl. CPC E06B 9/322

(57) ABSTRACT

A displaceable wand, comprising: an elongated member extending from a first end to a second end, an endless loop blind control element disposed within said elongated member and extending beyond at least one of the first and second ends; and a restrictor presented at one of the first and second ends, the restrictor extending through said endless loop blind control element to permit the elongated member to: a) hang from said endless loop blind control element and block access to the one end of the endless loop blind control element in a first position, and; b) be raised to a second position to expose said one end of the endless loop blind control element and rotate the endless loop blind control element in the second position.

### FIELD OF INVENTION

This invention relates to a displaceable wand with an endless loop blind control element comprising an elongated member extending from a first end to a second end, said endless loop blind control element disposed within said elongated member and extending beyond said first and second end, and a restrictor presented at one of said first and second ends and extending through said endless loop blind control element to permit said displaceable wand to hang from said endless loop blind control element in a first position and permit rotation of said endless loop blind control element in a second position.

### BACKGROUND OF THE INVENTION

Blinds for building openings, such as windows, doors and the like, may be operated either simply down and up, in the case of e.g. roller blinds, or in the case of for example vertical shade panels, the vertical shade panels may be rotated open or closed.

The control elements for these blind operations are usually in the form of an endless cord or chain. The control element simply hangs down along one side of the building opening, in an endless loop.

Other forms of blinds and window coverings may also be operated by means of an endless control element hanging in a loop.

In the past this system has been widely used, and experience was believed to be mainly satisfactory. In some cases a pendant weight was located on the loop, to assist in controlling it.

U.S. Pat. No. 4,932,456, inventor G Buxbaum, shows the usual form of blind chain and drive sprocket gear on the blind roller such as being standard in the art.

However safety considerations for some time have been forcing Government agencies seek further ways to restrict unsafe or unwanted access to the endless loop type of control element. The intent of these considerations has been mainly to prevent any chance that the element may possibly create a hazard to children, or handicapped persons, or even pets. Recent legislation in Canada has mandated that endless loop blind control elements cannot be extended more than 8 centimeters or 25 centimeters away from the wand so that a child may not be able to accidentally entangle the endless loop blind control element around its head. Furthermore these recent regulations in Canada require an endless loop blind control element not to be able to be manually exposed by more than 8 inches or 25 centimeters without the use of tools.

In addition, by guiding and controlling the loop of the element, its operation by anyone becomes somewhat easier. The element is prevented from becoming twisted, or entangled with any other blinds controls, curtains or the like.

The prior art includes US 2019/0195014.

### SUMMARY OF THE INVENTION

It is an aspect of this invention to provide a displaceable wand, comprising; an elongated member extending from a first end to a second end, an endless loop blind control element disposed within said elongated member and extends beyond at least one of the first and second ends; and a restrictor presented at one of the first and second ends, the restrictor extending through the endless loop blind control element to permit said elongated member to:
a) hang from the endless loop blind control element and block access to the one end of the endless loop blind control element in a first position, and;
b) be raised to a second position to expose the one end of said endless loop blind control element and rotate the endless loop blind control element in a second position.

In one embodiment the first and second ends comprise an upper end and a lower end respectively and the restrictor is positioned at said lower end.

In another embodiment the elongated member comprises a tube, where for example the tube is selected from the group having a rectangular, circular, oval, poly-sided and transparent cross section.

In one embodiment the endless loop blind control member hangs from a blind control adjacent the upper end of the tube. The blind control includes either a sprocket, clutch or pully and the endless loop blind control element hangs from the sprocket, clutch or pulley.

In one embodiment the restrictor is fastened to the lower end of the tube. The restrictor has an open restrictor end having the same cross-section as the lower end of the tube and a transit end having two transit openings separated by an abutment to permit the endless loop blind control element to transit around the lower end of the wand. In one embodiment the abutment has a curved surface.

In another embodiment the wand includes a least one magnetic member disposed between the upper and lower ends of the tube; wherein the wand hangs substantially vertical to a window frame and the window frame includes a magnetic metal adjacent the magnetic member for magnetic attraction there between.

In another embodiment the wand hangs substantially vertical to a window frame and the window frame includes a tensioning device traversed by a lower end of the endless loop blind control element to keep the endless loop blind control element in tension. The tensioning device includes a flap that is moveable between an open position to insert said lower portion of said endless loop blind control element into said tensioning device and a closed position. The tensioning device can include a socket opening to engage with a hand crank to rotate said endless loop blind control element.

In another embodiment the wand hangs substantially vertical to a window frame and the window frame includes a retainer to retain the wand against the window frame in the vertical position.

In a further embodiment up to 8 inches or 20 centimeters of the lower end of the endless loop blind control element is exposed in said second position.

In yet another embodiment the tube includes a first magnetic member at the lower end and a second magnetic member at the upper end.

In another embodiment the elongated member includes an upper guide presented at the upper end of the elongated member for guiding the endless loop blind control element.

The endless loop blind control element comprises a cord having spaced beads disposed along the cord and the curved surface is longer than the distance between said spaced beads.

In one embodiment the tube is rectangular in cross section and transparent.

In another embodiment displaceable wand comprises an elongated transparent tube extending from an upper end to a lower end; an endless loop blind control element disposed within said transparent tube and extending beyond said upper and lower end of said elongated transparent tube; an abutment at said lower end of said tube extending through said endless loop blind control element to permit said elongated transparent tube to:
a) hang from a lower end of said endless loop blind control element and block access to said lower end of said endless loop blind control element in a first position, and;
b) be raised to a second position to expose said lower end of said endless loop blind control element and manually rotate said endless loop blind control element in said second position.

In another embodiment the restrictor is selected from a transverse member extending through said cross-section of said tube. In one embodiment the transverse member comprises a screw extending through a first wall and either touching or extending through a second wall without penetrating the second wall. The restrictor or screw can be at or spaced inwardly from said lower end.

In a further embodiment there is a plug at said lower end and said screw extends through said first wall, through said plug and either touching or extending into the second wall without penetrating through said second wall; said plug disposed at the lower end of said tube, without extending beyond said lower end.

In another embodiment the restrictor comprises a tensioning device traversed by said endless loop blind control element at said lower end, wherein said tensioning device has an upper end larger than said lower end of said wand and wherein said tensioner is operable to be connected to a widow frame to keep said endless loop blind control element in tension.

In a further embodiment said restrictor comprises a connector capturing said endless loop blind control element at said lower end, wherein said connector is operable to be connected to a widow frame to keep said endless loop blind control element in tension. A tie strap is used to connect said connector to said endless loop blind control element.

In a further embodiment there is provided a bracket having one side connected to a window frame and another side connected to the tensioning device so as to bias said wand away from a window blind.

The window frame can include an upper, middle and lower magnetic metal for magnetic attraction to said at least one magnetic member.

It is another aspect of this invention to provide a displaceable wand, comprising; an elongated member extending from an upper end to a lower end, an endless loop blind control element disposed exterior to said elongated member and extends beyond at least one of said upper and lower ends; and a plurality of spaced fixed stops disposed along the length of the wand.

In one embodiment the stops are spaced so that the endless loop blind control element cannot be extended more than up to 8 inches or 20 centimeters. in another embodiment the stops are fixed to the outside surface of said wand. In another embodiment each said stop comprises two opposite halves connected together.

In another embodiment there is a fastener at the upper end of the wand to secure the wand against a window frame and one magnetic member at the lower end of the wand. The fastener can comprise a screw having a shoulder bearing against the window frame and the wand includes a hole for the screw wherein said hole includes angled sides.

It is another aspect of the invention to provide a plurality of spaced strops or collars either; disposed along the length of a wand; or disposed along the length of a frame of a window; where each stop or collar is secured to the wand or frame of a window and includes an endless loop blind control element disposed through each said stop or collar; and a restrictor at a lower end disposed through the lower end of said endless loop blind control element.

In one embodiment the plurality of spaced stops or collars is secured around the wand or on one surface of the wand or along the frame of said window. In another embodiment of the invention the wand is hollow or solid.

In another embodiment of the invention the wand is solid and the stops or collars are secured around the wand with a lower housing disposed at a lower end of the wand, the housing includes a pulley, socket or curved passage to receive a lower end of said endless loop blind control element.

In another embodiment the wand is in two pieces and further includes a connector for connecting an end of each of said two pieces of said wand; wherein each said two pieces of said wand and said connector receive said endless loop blind control element there through when said two pieces of said wand are either connected or disconnected by said connector, and the other end of one of said pieces of wand includes a fastener extending through said wand and the other end of said the other one of said wand includes an end of the endless loop blind control element adapted to hang from a sprocket or pulley of said blind.

In another embodiment there is an upper connector housing disposed at said upper end that can pivot, swivel or move from side to side and front and back, or lay in a substantially vertical resting position.

In another embodiment there is a tensioner disposed at the lower end of said wand, said tensioner displaceable toward said upper end of said wand.

Another aspect of this invention relates to a window blind wand and a fastener wherein the fastener is disposed at: an upper end of the wand to secure the wand against a window frame; or at a lower end of the wand to secure the wand against a window frame; or both the upper end of the wand and the lower end of the wand to secure the wand against a window frame; or between the upper end of the wand and lower end of the wand to secure the wand against a window frame.

These and other features of the invention shall now be described in relation to the following drawings.

### SUMMARY OF DRAWINGS

FIG. 1 is a perspective view of the wand for operating a window fabric of a window blind or shade in a first closed position.

FIG. 2 is a perspective view of the wand for operating a window fabric of a window blind or shade. in a second operable position.

FIG. 3 is a front elevation view of the wand of FIG. 1 in the first closed position.

FIG. 4 is a front elevation view of the wand which is pulled to the side showing magnets.

FIG. 5 is a side elevation view of the wand having magnets and where the wand pulled away from the frame of a window and manipulated by raising the wand to a second raised operable position.

FIG. 6 is a front elevation view of FIG. 5.

FIG. 7 is a side elevation view of the wand where the wand is pulled away from the frame of a window and manipulated by lowering the wand to a first lower position.

FIG. 8 is a front elevation view of FIG. 7.

FIG. 9 is a side elevation view of the wand with a clip where the wand is in a second operable position.

FIG. 10 is a side elevation view of the wand with a clip where the wand is in a first closed position.

FIG. 11 is a front elevation view of the wand with a tensioner with the wand in the first closed position.

FIG. 11B is a perspective view of an electrical motor that can be used as an alternative to a hand crank.

FIG. 12 is a side elevation view of the wand with a tensioner with the wand in the first closed position.

FIG. 13 is a front elevation view of the wand with a tensioner with the wand in the second operable position.

FIG. 14 is a side elevation view of the wand with a tensioner with the wand in the second operable position.

FIG. 15 is a front elevation view of the wand with a tensioner with the wand in the second operable position showing a hand crank.

FIG. 16 is a side elevation view of the wand with a tensioner with the wand in the second operable position showing a hand crank.

FIG. 17 is a perspective view of the wand with a tensioner and hand crank.

FIGS. 18A, 18B, 18C, 18D, 18E, 18F and 18G are perspective and cross-sectional views of others embodiment of the invention.

FIG. 19 is another embodiment of the invention showing another version of the tensioner.

FIGS. 20A and 20B illustrate the use of two upper magnetic positions.

FIGS. 20C and 20D show other embodiments illustrating the use of a screw at the upper end of the wand and magnet at the lower end and details of an embodiment of a screw respectively.

FIGS. 21A and 21B are front and side views of a connecting hook with a tie clip through the endless loop blind control element.

FIGS. 22A and 22B is a perspective view and cross-sectional view of another embodiment of the invention showing a plurality of fixed stops disposed around and along the length of the wand.

FIGS. 23A and 23B is a front and side view of a tensioner disposed to the side by a bracket.

FIGS. 24A and 24B are a perspective view of another embodiment of the invention where the plurality of fixed spaced stops are secured to a frame, and a side view of the stop, respectively.

FIGS. 25A and 25B show another embodiment of the invention where the elongated member is solid with a plurality of spaced stops or collars secured around the elongated member, and a detailed side view of the stop or collar.

FIGS. 25C, 25D, and 25E show another embodiment of FIGS. 25A and 25B.

FIGS. 26A and 26B illustrate another embodiment of the invention showing a connector to connect two ends of and elongated member or wand.

FIGS. 27A, 27B, 27C, 27D and 27E show another embodiment of the invention showing a wand having an upper connector that can pivot from side to side and front and back.

FIGS. 28A and 28B illustrate another embodiment similar to FIG. 27 but with a tensioner at the bottom end of the wand with a cam in one closed position and the cam in a second operable or open position

### DETAILED DESCRIPTION OF THE INVENTION

Like parts are given the same number throughout the drawings.

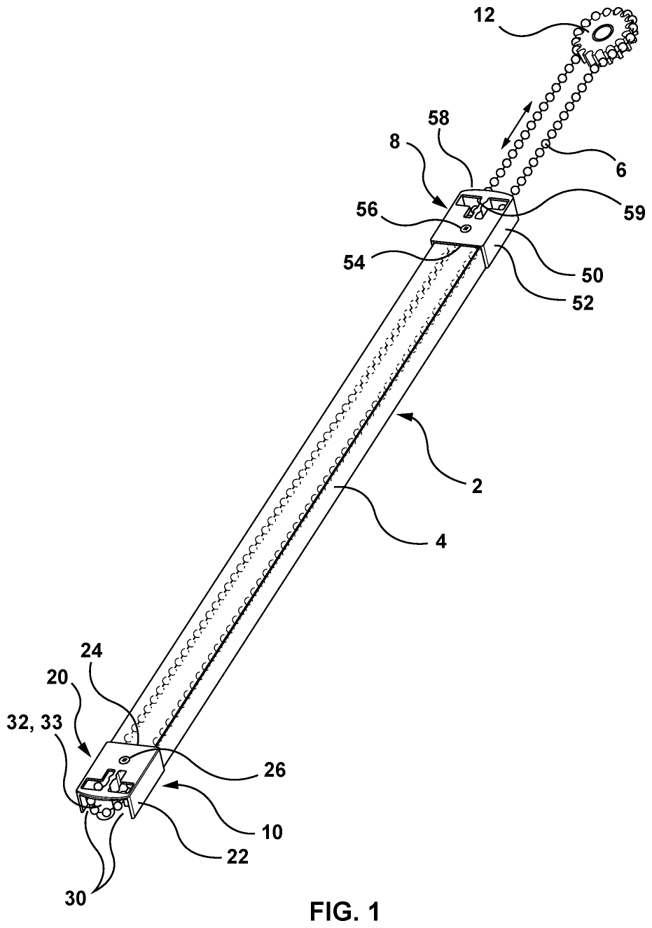

FIG. 1 is a perspective view of a wand 2 for operating a window fabric of a window blind or shade. The wand 2 comprises an elongated member 4 which in one embodiment is a tube having a rectangular cross-section. The elongated member 4 extends from a first or upper end 8 to a second or lower end 10. Other cross-sections can be used such as circular, oval, square or poly-sided. The elongated body can be made of suitable material such as plastic or the like. In the embodiment shown the elongated member is transparent.

An endless loop blind control element 6 is disposed within the elongated member 4 (which may be shaped generally as a tube) and extends beyond at least one of the first or upper end 8 and second or lower ends 10. The endless loop blind control element can consist of a cord, balls spaced along a cord in a manner well known to those persons skilled in the art relating to window blinds or shades.

The endless loop blind control element extends 6 beyond the upper end 8 of elongated member 4 to “hang from” and engage with a sprocket 12 of a blind control. The sprocket 12 can be part of a clutch control 14 in a typical window blind or shade. The clutch control 14 is located in a housing 15 having a clutch housing opening 17 to receive a portion of the endless loop blind control element 6. Instead of a sprocket a pulley can be used.

The wand 2 includes a restrictor 20 or support at the lower end 10 of the elongated member 4. The restrictor 20 can be integral with the elongated member 4 or alternatively as shown can consist of a separate restrictor body 22 having an open restrictor end 24 which has the same cross section as the lower end 10 of elongated member 4 so as to telescope therein. In one embodiment the restrictor body 22 is fastened to the lower end of elongated member 4 by a screw 26 or other suitable fastening means such as an adhesive. The restrictor body 22 has a transit end 28 opposite the open restrictor end 24. The transit end 28 has two transit openings 30 separated by an abutment or support surface 32 to permit or accommodate the endless loop blind control element to transit around the lower end 10 of the elongated member 4 of the wand 2.

The abutment 32 has a curved surface 33 that contacts the endless loop blind control element 6. The curved surface 33 is longer than the distance between the spaced beads of the endless loop blind control element 6 so that the endless loop blind control element rotates around the abutment 32 smoothly without any substantial snags. The abutment 32 can extend or project beyond the transit end 28 or alternatively the abutment 32 can be positioned within the restrictor body 22. Alternatively the abutment may be part of the lower end of the elongated member or inside the lower end of the tube 4.

The upper end 8 of the elongated member 4 includes a guide 50. The guide 50 can be integral with the elongated member 4 or alternatively as shown can consist of a separate guide body 52 having an open guide end 54 which has the same cross section as the upper end 8 of elongated member 4 so as to telescope therein. In one embodiment the guide body 52 is fastened to the upper end of elongated member 4 by a screw 56 or other suitable fastening means such as an adhesive. The guide body 52 has a guide transit end 58 opposite the guide end 54. The guide transit end 58 has two transit openings 50 separated by support surface 59 to permit or accommodate the endless loop blind control element 6 to transit through the upper end 8 of the elongated member 4 of the wand 2.

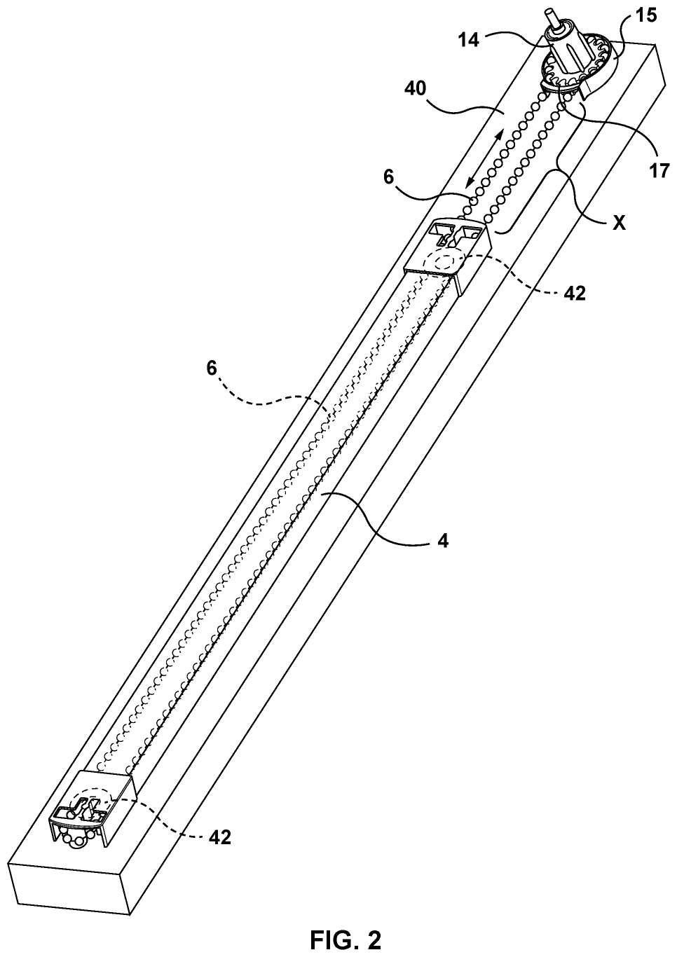

The wand 2 hangs from a socket 12 or clutch assembly 14 of a window blind adjacent a frame 40 of a window shown in FIG. 2. The wand 2 in one embodiment includes at least one magnetic member 42 disposed between the upper end 8 and lower end 10 and the window frame 40 also includes at least one magnetic metal 44 that is attracted to the magnetic member 42 for magnetic interaction there between when the wand 2 “hangs” substantially vertically from the sprocket 12 or clutch assembly 14 due to gravity. In one embodiment there is one magnetic metal 44 adjacent the lower end 10 of wand 2. The strength of the magnet can be selected to make it difficult for a child to separate the wand 2 or magnetic member 42 from the magnetic metal 44. This acts as an added level of child proofing the wand 2. In another embodiment there can be two magnetic metals 44 at the frame 40 adjacent the upper end 8 and lower end 10 of the wand 2.

The magnetic material 42 can be secured to the wand by a fastener 50 or adhesive such as a screw 50. The magnetic metal 44 can be a metal washer 52 or the like that is secured to the frame 40 by a screw or by adhesive. In one embodiment the magnetic material 42 is fastened to the restrictor body 22 such as a screw or fastener, or adhesive.

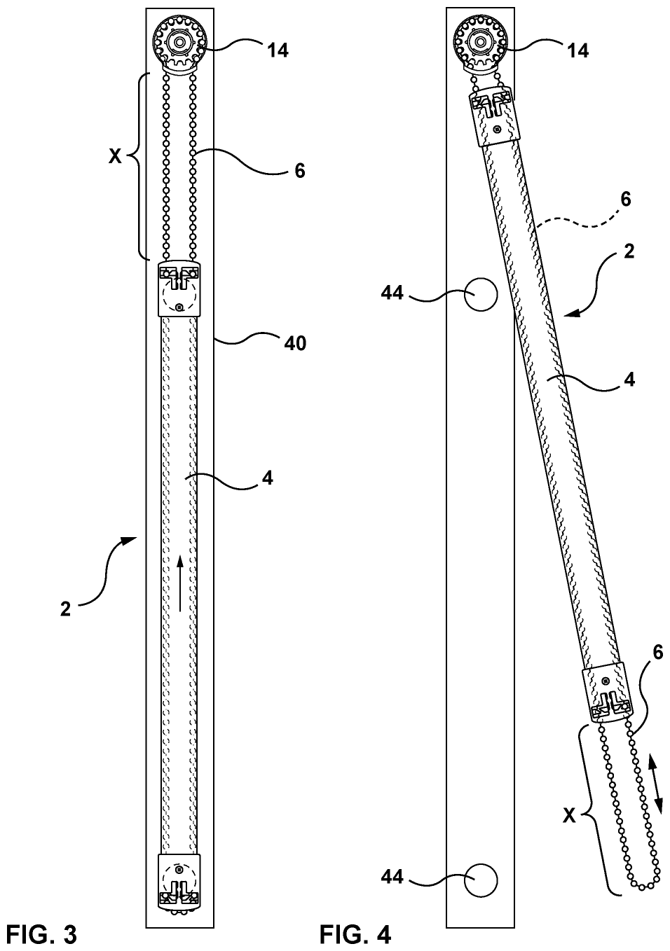

The restrictor 20 and in particular the abutment or support surface 32 extends through the endless loop blind control element 6 to permit the elongated member 4 to:
a) hang from said endless loop blind control element 6 and block access to the lower end 10 of the endless loop blind control element 6 in a first or lower position, as shown in FIG. 4; and
b) be raised to a second or open position to expose the lower end of said endless loop blind control element 6 and rotate said endless loop blind control element in said second or operable position as shown in FIG. 3.

In particular the abutment or support surface 32 bears against or contacts the lowest part of the endless loop blind control element 6 and prevents the wand 2 and elongated member 4 to drop any further.

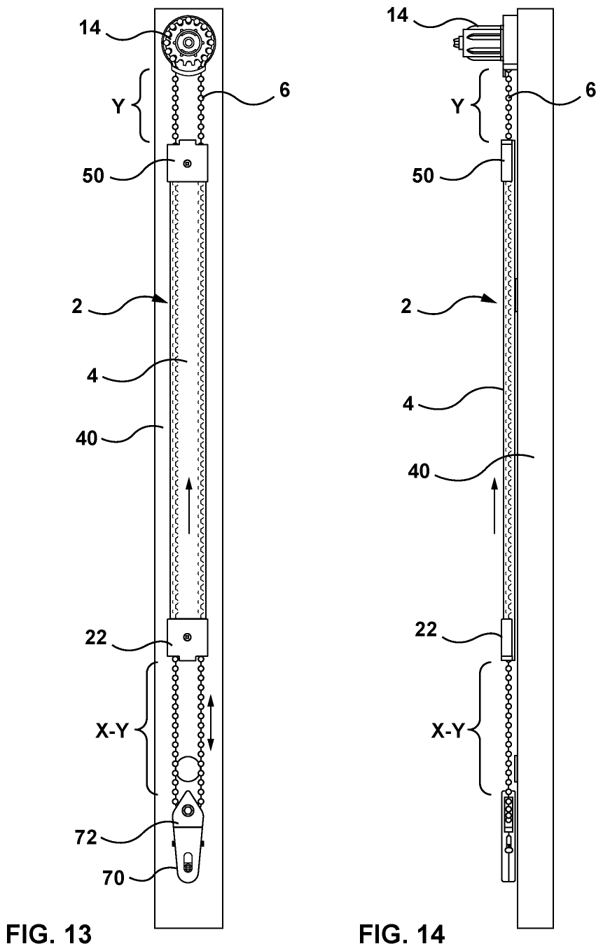

The wand 2 or elongated member 4 is shorter in length than the loop of endless blind control element 6 so that a length X of the endless loop blind control element is exposed above the guide 50 in the lower position shown in FIG. 4, while the same length X of the endless loop blind control element is exposed below the lower end 10 when the wand 2 is in the open position shown in FIG. 4. The wand 2 can be raised up to the total length X or alternatively the wand can be raised just a portion Y as shown in FIGS. 13 and 14 for example within the scope of this invention. In some jurisdictions such as Canada government authorities regulate the length of endless loop blind control element that can be exposed to protect children from accidental entanglement with the endless loop blind control element 6. In one embodiment X can be selected at 8 inches or 20 centimeters.

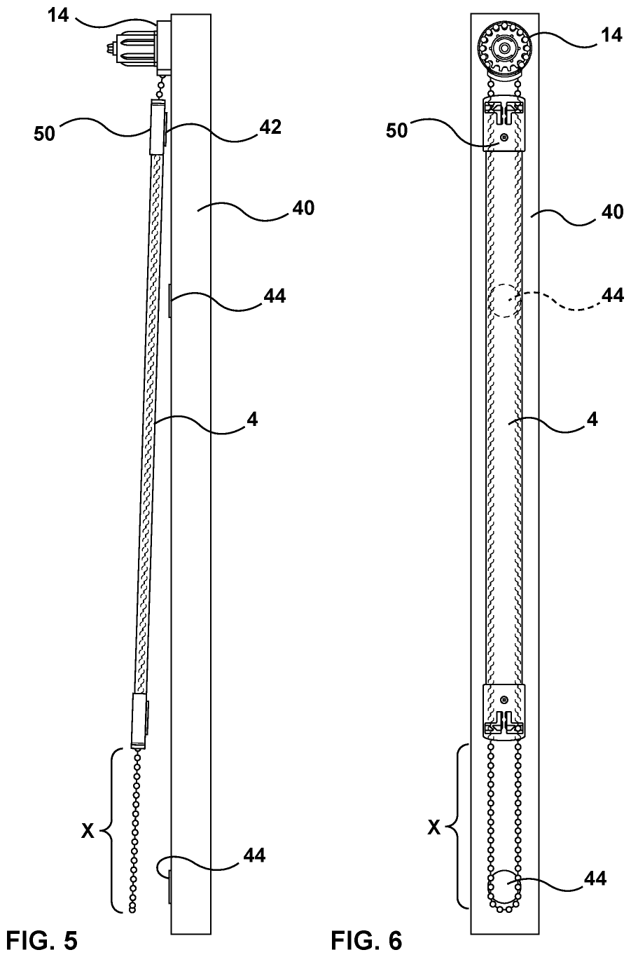

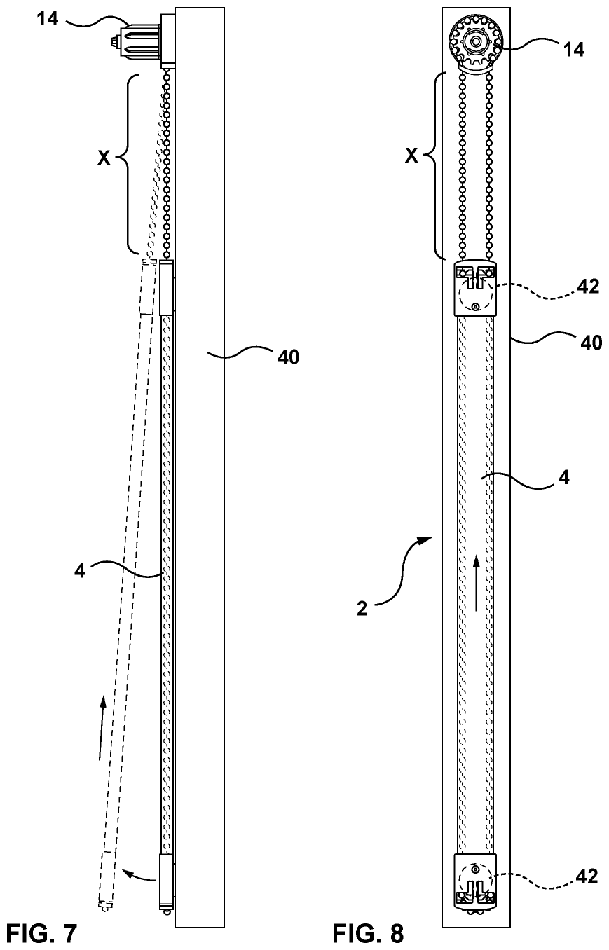

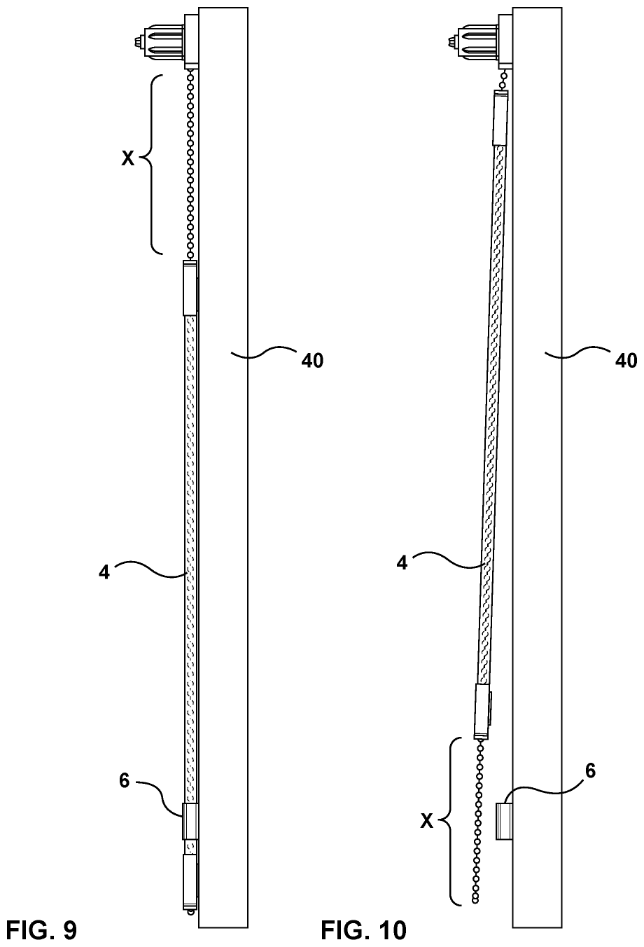

The wand 2 can be pulled or swung in any direction since the wand 2 freely hangs from the sprocket 2 or clutch assembly 14 as shown in FIGS. 4 and 5.

Alternatively the magnetic material 42 and magnetic metal 44 can be replaced by capturing device or retainer 60 such as a clip 60 for example which is attached to the frame 40. The outer periphery or surface of elongated member 4 can be pressed against the clip 60 to be removeably retained thereby. Then when the wand 2 is in use the wand 2 is pulled away from the clip 70 and then the wand 2 is manually moved to the open position and/or operable position the endless loop blind control element 6 is manually moved to rotate the socket 12 and raise or lower the window covering or fabric.

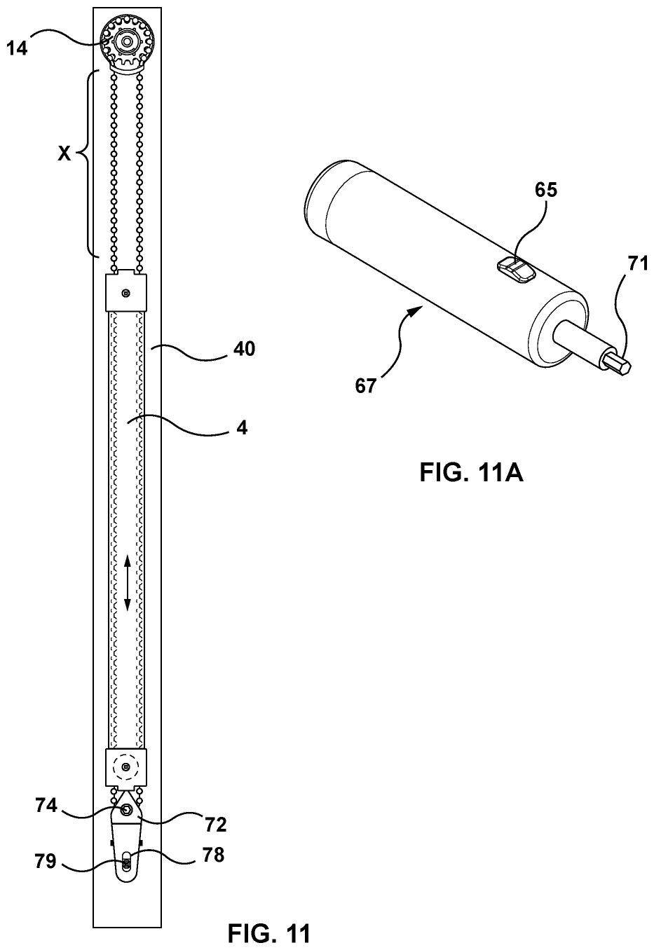

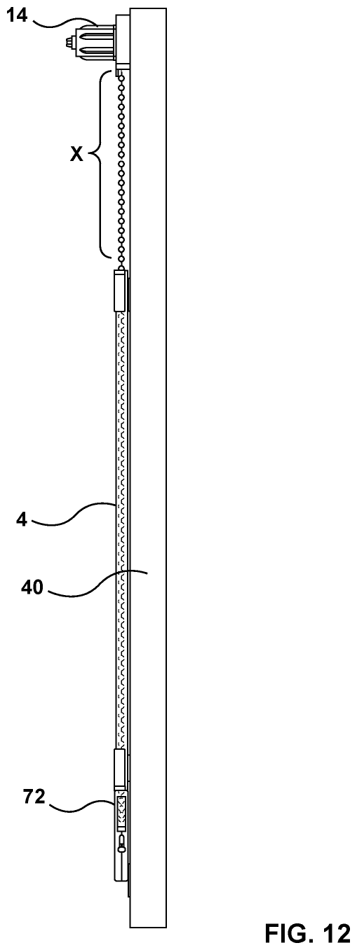

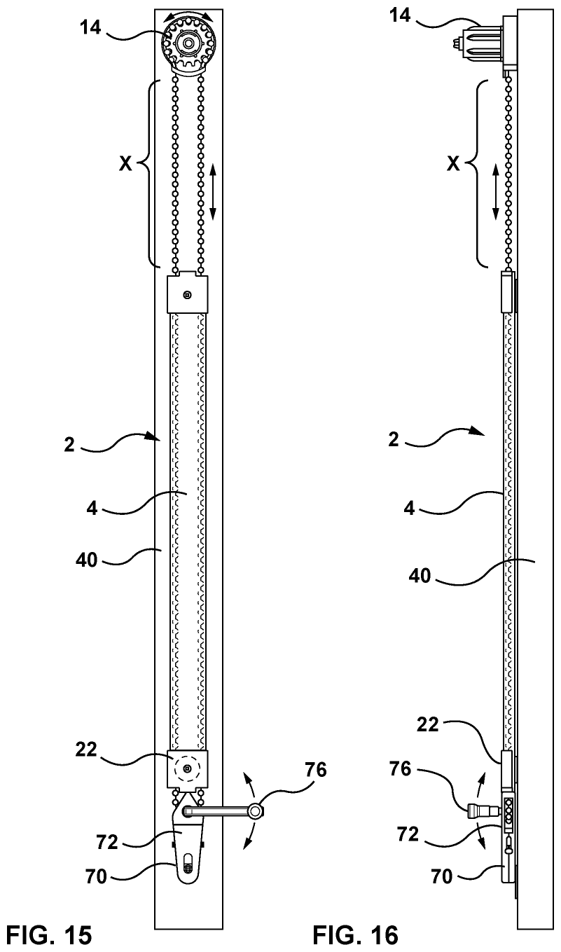

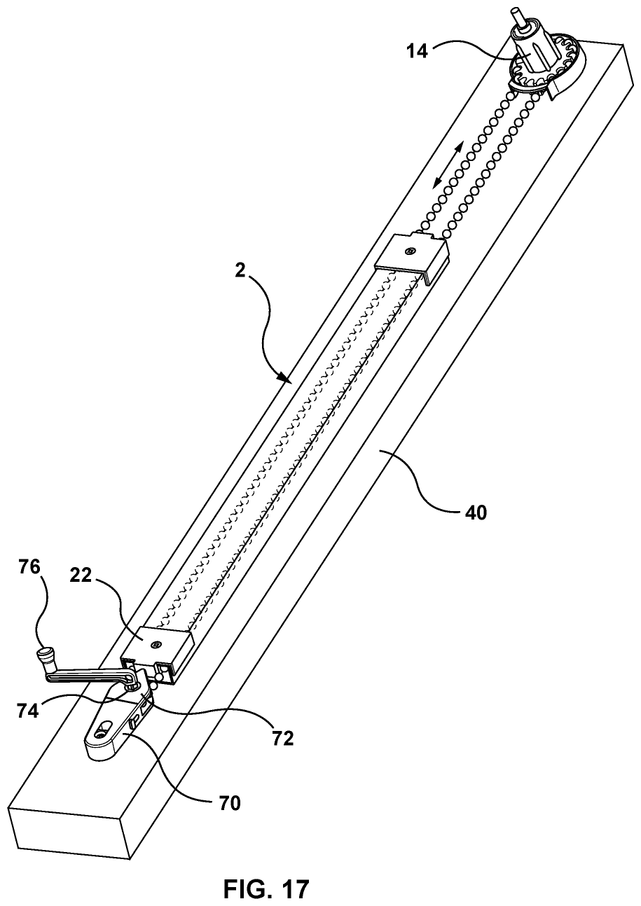

As a further alternative as shown in FIGS. 13-17 a tensioning device 70 can be attached to the frame 40 where the tensioning device 70 is traversed by the lower portion of the endless loop blind control element 6 to keep the endless loop blind control element 6 in tension. The tensioning device 70 includes a flap 72 that is moveable between an open position to insert the lower portion of the endless loop blind control element 6 into the tensioning device around a sprocket or pulley (not shown) located inside the tensioning device 70 and a closed position. The tensioning device 70 can include a socket opening 74 to engage with a hand crank 76 to rotate the endless loop blind control element 6. Alternatively an electric motor 67 as shown in FIG. 11A can be used in place of a hand crank 76 where the male end 71 includes a hexagonal end 71 to fit within the female end or hexagonal hole 74 so as to move the end of the endless loop blind control element 6 in a clockwise direction or counter-clockwise direction depending on whether the switch 65 is pushed either up in one direction or down in a second direction. The tensioning device includes a slot 78 which accommodates a fastener 79 so as to fasten the tensioner 70 to the frame 40 by fastener 79 such as a screw 79. The fastener 70 includes the slot 78 so as to adjust the tension by moving the tensioner up or down along the slot 78.

The invention as described above illustrates a displaceable or moveable wand 2, comprising:
a) an elongated transparent tube 4 extending from an upper end 8 to a lower end 10;
b) an endless loop blind control element 6 disposed within said elongated transparent tube and extending beyond said upper and lower end; and
c) an abutment 33 at said lower end 10 of said elongated transparent tube 4 extending through said endless loop blind control element 6 to permit said elongated transparent tube 4 to:
   i) hang from a lower end of said endless loop blind control element 6 and block access to said lower end of said endless loop blind control element 6 in a first position, and;
   ii) be raised to a second position to expose said lower end of said endless loop blind control element 6 and manually rotate said endless loop blind control element in said second operable position.

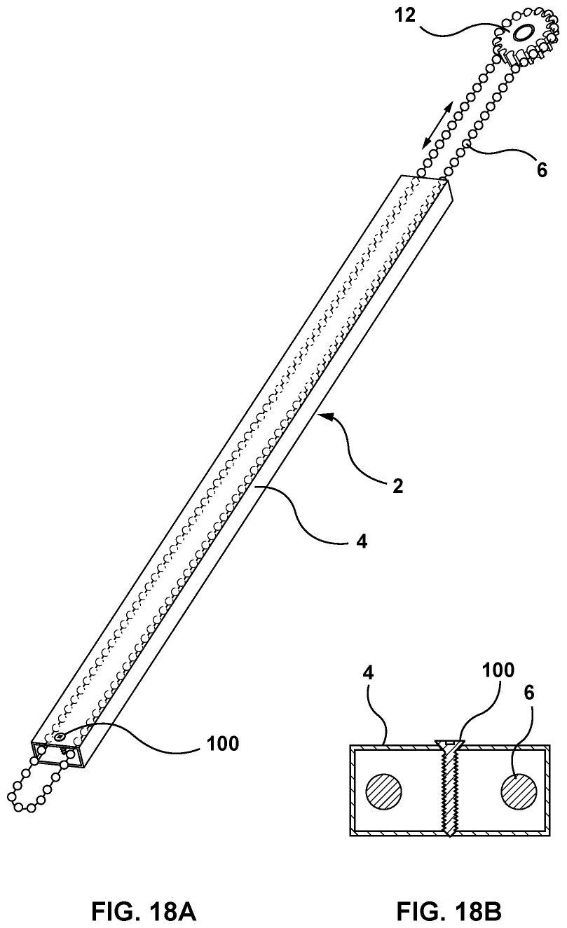

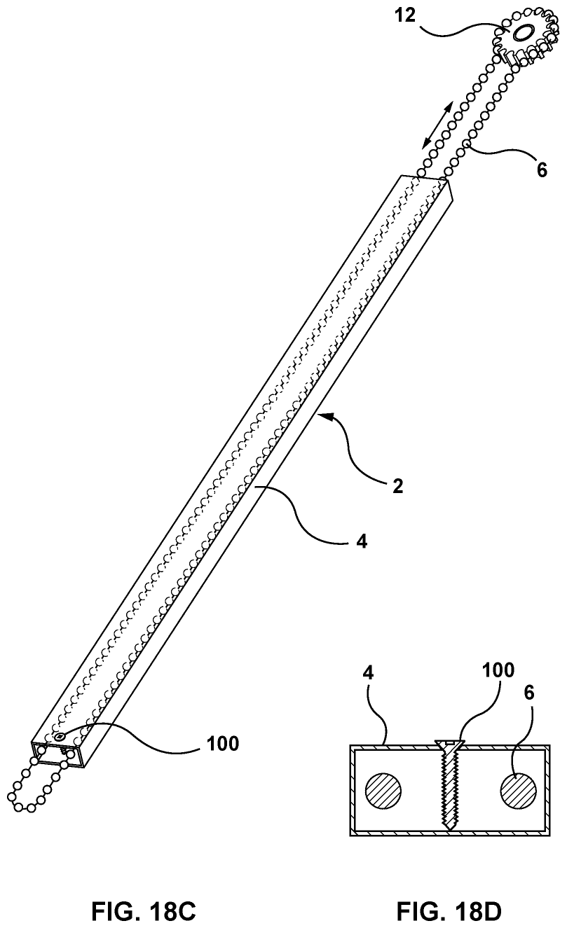

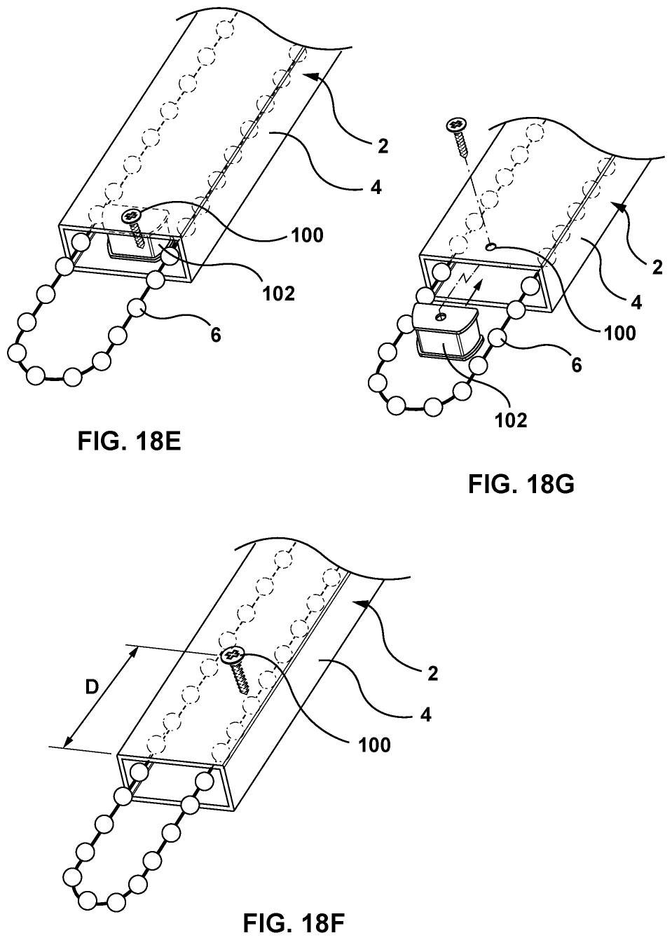

FIGS. 18A and 18B illustrates another embodiment of the invention where the restrictor 100 is selected from a transverse member extending through said cross-section of said tube. The transverse member 100 can comprise a screw 100 extending through a first wall of the elongated member 4 and either touching (FIGS. 18C and 18D) or extending through a second wall of the elongated member 4 without penetrating the second wall (FIGS. 18A and 18B).

The screw 100 can be spaced inward from said lower end 10 as shown in FIG. 18F.

FIGS. 18E, 18F, and 18G show in another embodiment the use of a restrictor, member or plug 102 at said lower end 10 and a screw 100 extending through a first wall, through the plug 102 and either touching (see FIGS. 18C and 18D) or extending into a second wall without penetrating through said second wall (see FIGS. 18A and 18B); said plug 102 disposed at the lower end 10 of said tube 4, without extending beyond said lower end 10.

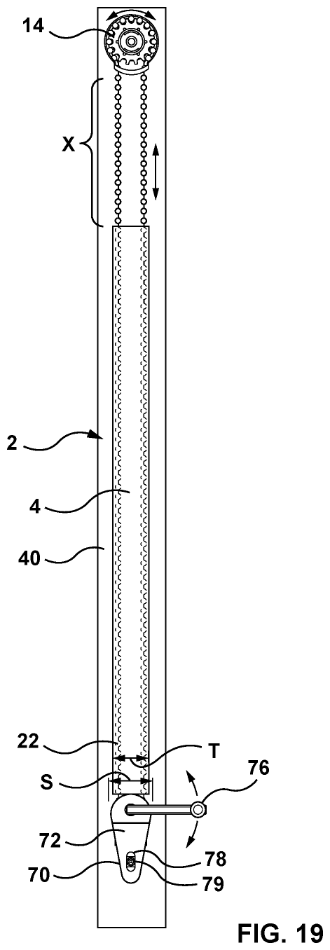

In another embodiment shown in FIG. 19 a tensioning device 72 is traversed by said endless loop blind control element 6 at said lower end 10, wherein said tensioning device 72 has an upper end larger than said lower end 10 of said wand 4 and wherein said tensioner 72 is operable to be connected to a widow frame to keep said endless loop blind control element 6 in tension. Since the upper end of the tensioner S is larger than the lower end T of the wand 6 the wand 4 cannot go beyond the tensioner 72 once in the second or lowest position; however the wand can be manually raised into the first or upper position as previously described. In other words S>T.

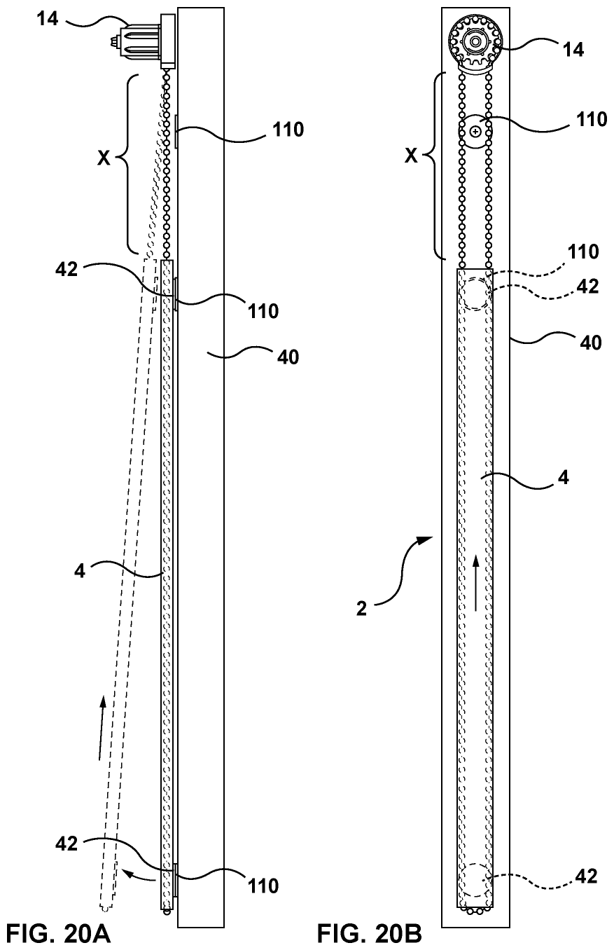

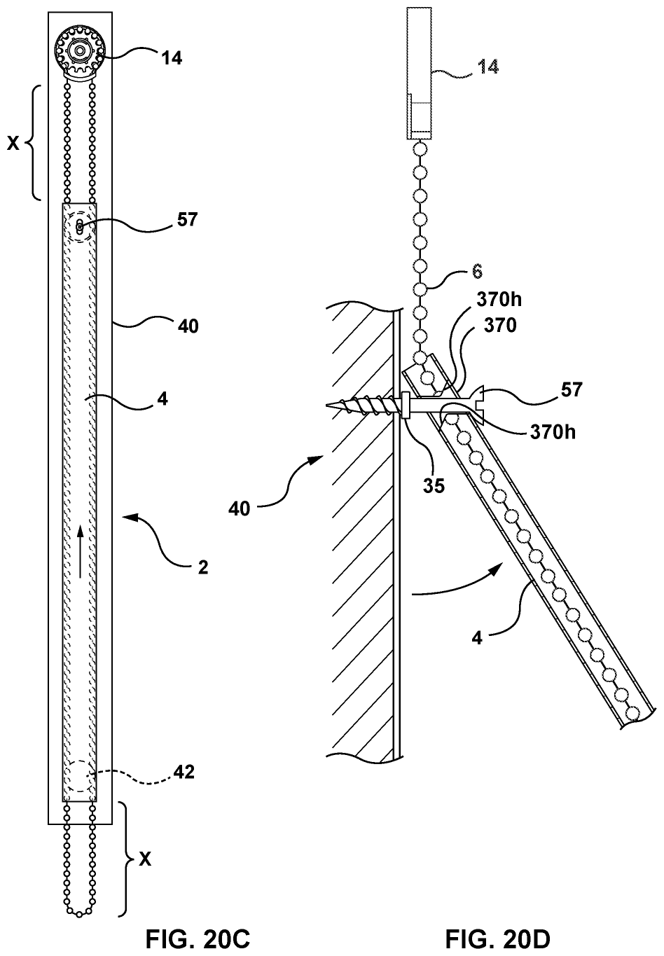

FIGS. 20A and 20B show the use of three metallic materials (upper, middle and lower). When the magnetic member 42 is raised opposite the upper magnetic material this allows a user to use both hands to manipulate the endless loop blind control 6 as previously described since the wand 4 is held in place by the magnetic attraction between the upper magnet 42 and the upper metallic material 110. Once completed the wand 4 can be moved down (or drop through the action of gravity) where upper magnet 42 is opposite the middle metallic material 110 so as to block access to the endless loop blind control element 6 in the second or lowest position.

FIG. 20C shows another embodiment of the invention where the upper end of the elongated member 4 is secured to a window frame 40 by a fastener such as a screw 57 so that the elongated member 4 can be swung about the screw 57. The screw 57 as shown in FIG. 20D can have a shoulder 35 to bear against the window frame 40 while the hole 370 in the elongated member 40 can have a hexagonal configuration or six angled sides 370h as shown, so that the shaft of the screw 57 contacts one of the six sides 370h to the hexagonal configured hole when the wand 4 is to swing out; making it possible to not only swing the elongated member about the screw but also away from the window frame 40; in other words the elongated member 4 can be manipulated in three (3) directions, namely to the right of the screw 57, to the left of the screw 57 and away from the frame 40 of the window. In this arrangement the is one magnet 42 and one metallic member 110 attached to the frame 40 so that the elongated member in the rest position (elongated member is substantially vertical). In use one would grasp the lower end of the elongated member 4 and pull the magnet 42 away from the metallic material 110 so as the manipulate the lower end X of the endless loop blind control element 6 or the upper portion X of the upper end of the endless loop blind control element 6 above the screw 57 to manipulate the endless loop blind control element 6.

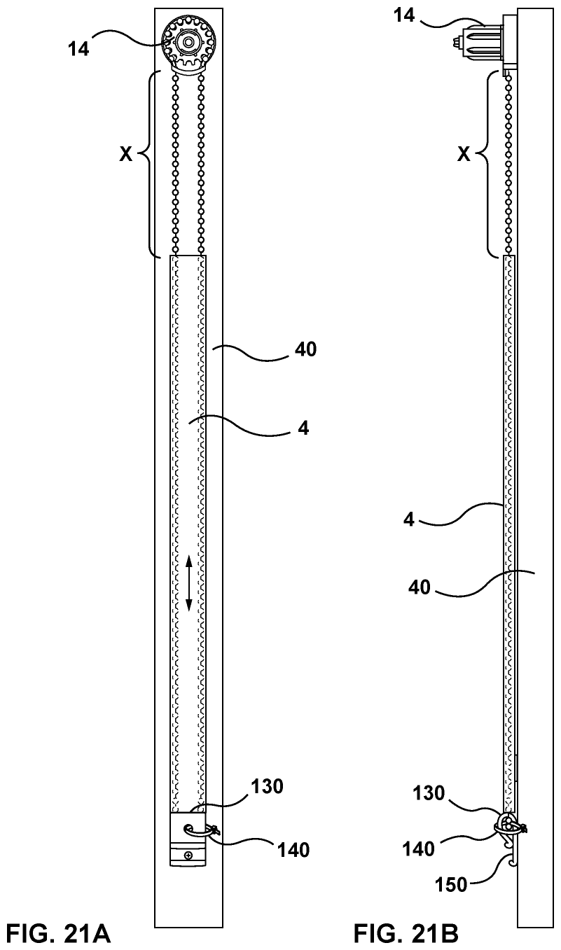

FIGS. 21A and 21B show another embodiment of the invention showing a connector 130 capturing said endless loop blind control element at said lower end 10, wherein said connector 130 is operable to be connected to a widow frame 40 to keep said endless loop blind control element 6 in tension. In particular the connector is generally looped as shown in FIG. 21B to capture an end of the endless loop blind control element. A tie strap 140 is used to connect said connector 130 to said endless loop blind control element 6 so that the tie strap 140 cannot be removed without the use of a tool such as scissors or snips and thereby conform to recent government regulations which require an endless loop blind control element 6 not to be able to be manually exposed by more than 8 inches or 25 centimeters without the use of tools.

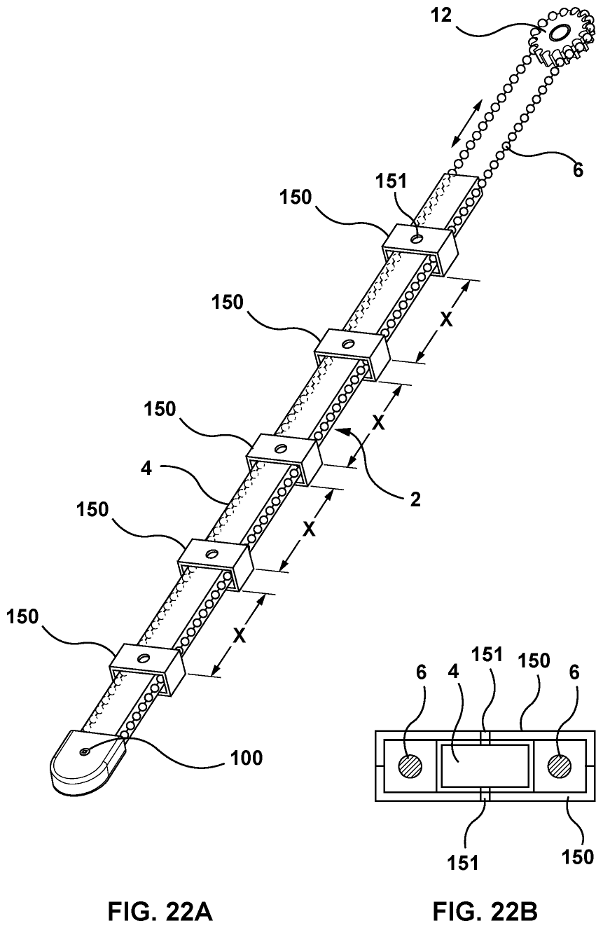

FIGS. 22A and 22B illustrate a displaceable wand 2, comprising; an elongated member 4 extending from an upper end 8 to a lower end 10, an endless loop blind control element 6 disposed exterior to said elongated member 4 and extends beyond at least one of said upper 8 and lower ends 10; and a plurality of spaced fixed stops 150 disposed along the length of the wand. In one embodiment the stops 150 are spaced apart by X, for example so that the endless loop blind control element is not exposed more than up to 8 inches or 20 centimeters. The stops 150 are fixed to the outside surface of said wand 4 by fasteners 151 which can be any fastener such as a rivet, screw or even adhesive. The lower end 10 includes a housing 405 which can be secured to the elongated member 4 by a screw 100 or other adhesive. the housing 405 receives the lower end of the endless loop blind control element 6 around a pulley, sprocket or curved pathway (not shown).

In operation the wand 2 can be lifted to the upper position and manipulated as previously described or the endless loop blind control element 6 can be manually pulled sideways or generally perpendicular to the wand 4 so as to expose no more than 8 inches or no more than 25 centimeters of endless loop blind control element 6 between two adjacent stops 150 to manipulate the endless loop blind control element 6. As shown in FIG. 22B the stops 150 can in one embodiment comprise two opposite stop shells where the endless loop blind control elements are disposed between the elongated member 4 and stops 150.

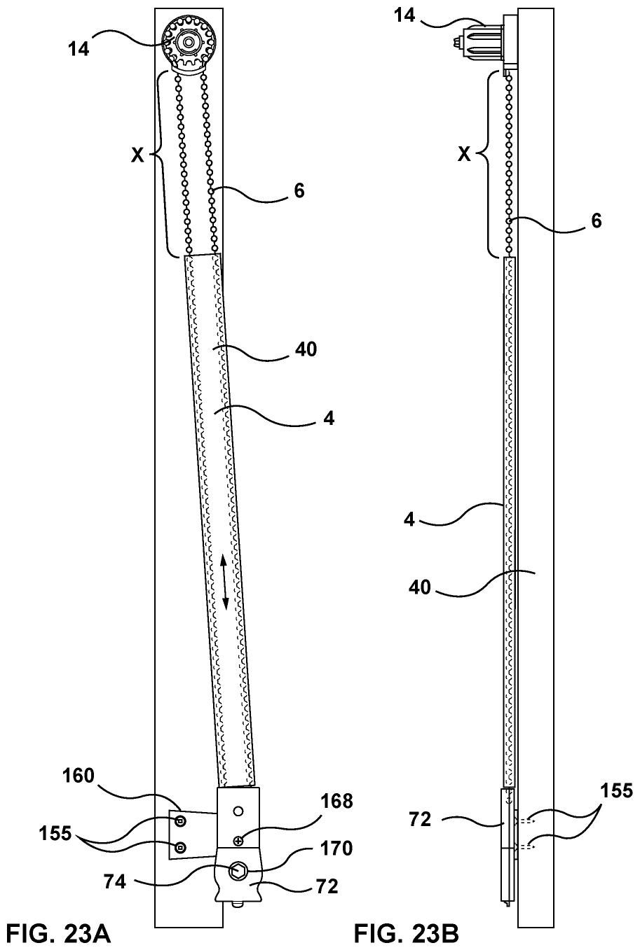

FIGS. 23A and 23B show a bracket 160 having one side connected to a window frame 40 by screws 155 and another side of the bracket 160 connected to the tensioning device 72 by a screw 168 so as to bias said wand away, or to one side of a window blind as shown.

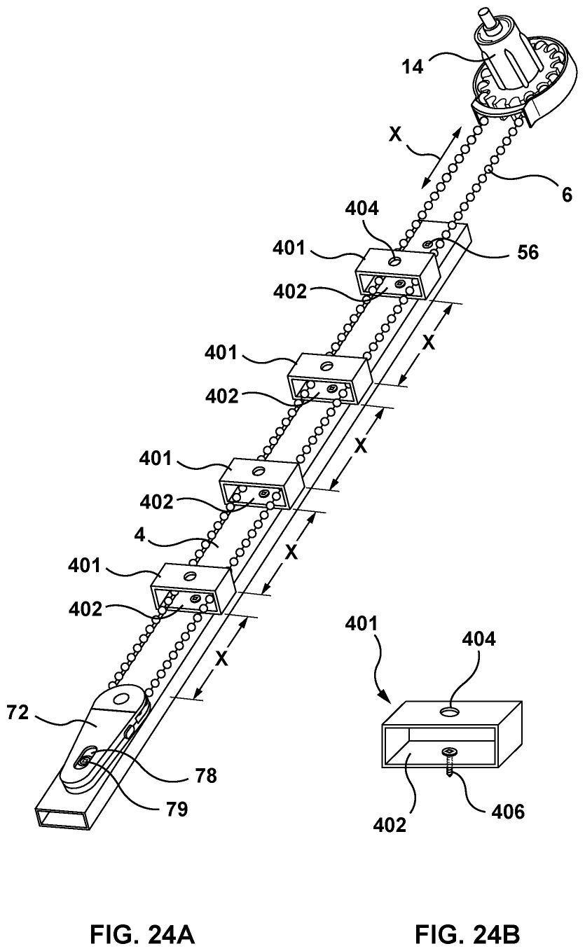

FIGS. 24A and 24B show that the plurality of spaced stops 401 can be secured to the frame 40 of a window as shown where each stop 401 has a hole 404 to receive a fastener such as a screw 406 that can be screwed into the window frame 40. The stops 401 are spaced apart no more than X as previously described.

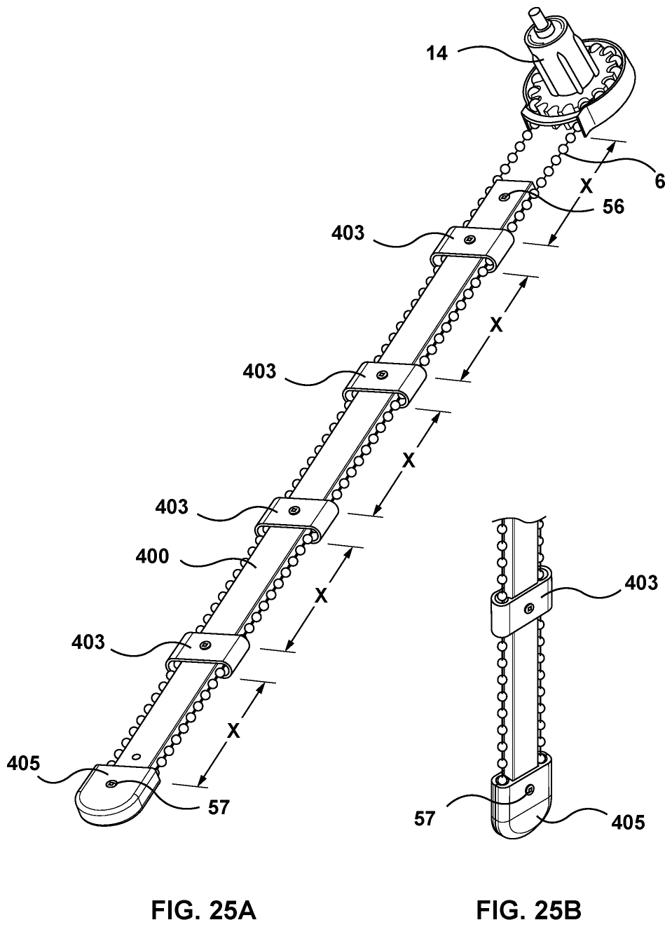

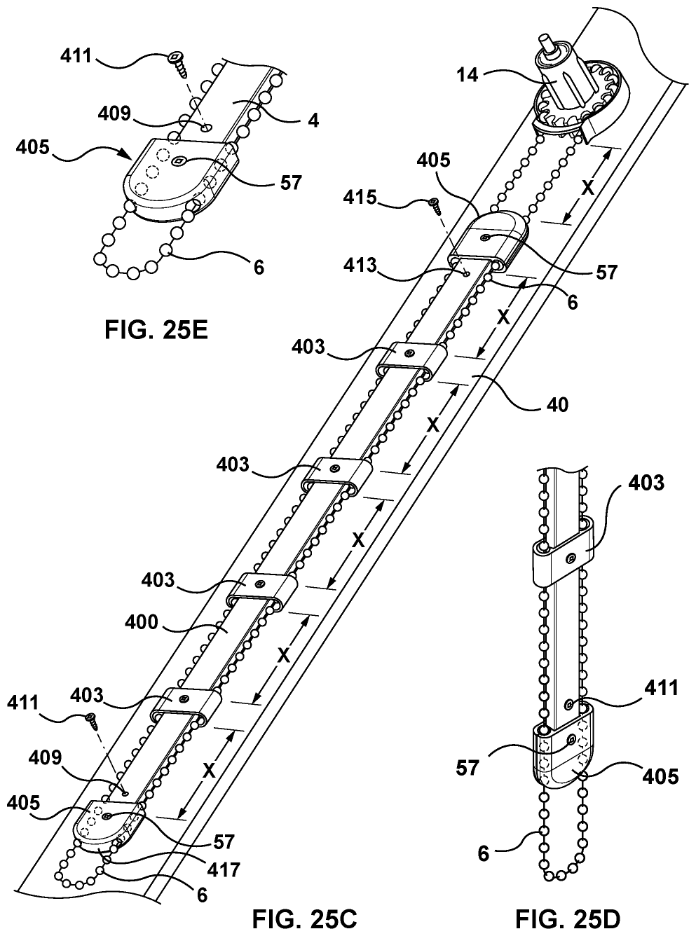

FIGS. 25A and 25B show another embodiment of the invention where the elongated member 4 is solid with a plurality of spaced stops or collars 403 spaced apart no more than a distance of X as previously described where the collars are fastened around said wand 4 with the endless loop blind control element 6 passing on either side of the wand 4, between the sides of the wand 4 and each of the spaced stops or collars 403, secured around the elongated member, FIG. 25B is a detailed side view of the stop or collar. The lower end of the wand 4 includes a housing 405 having a hole 57 there through to receive a fastener. The housing includes a pulley, sprocket or passage (not shown) that receives the lower end of the endless loop blind control element 6 so the endless loop blind control element can traverse the end of the wand 4 as previously described.

FIGS. 25C, 25D, and 25E show another embodiment of FIGS. 25A and 25B. FIG. 25E shows another embodiment of the housing 405 located at the lower end 10 which has two substantially parallel passage ways there through to receive the lower end of the endless loop blind control element as shown in FIG. 25C. The same housing 405 is also shown at the upper end 8 of the wand 4 where the housing 405 is secured by a screw 57 to the elongated member or wand 4.

The elongated member or wand 4 can be secured to the window frame 40 by fastener 415 through hole 413 and into the window frame 40 so as to rotate or pivot about screw 415. Alternatively the elongated member or wand 4 can instead be fastened at the lower end 10 by screw 411 passing through hole 409 and into the window frame 40 and the wand pivot or rotate about fastener 411. Also a further embodiment comprises a fastener or screw 411 at the bottom end 10 that is secured into the frame 40 and a second fastener 415 securing the upper end 8 of the elongated member or wand 4 to the window frame 40. The location of the fasteners 411 and 415 can be chosen anywhere between the upper end 8 and lower end 10 to produce the desired results described above.

The outer end can be curved as shown as 417 so that when the elongated member or wand 4 is rotated about fasteners 411 or 409 the endless loop blind control element 6 is less likely to “snag” or “catch” against the corners of housing 405.

Although a screw 411 and 415 are shown any type of fastener can be used such as a rivet or pin.

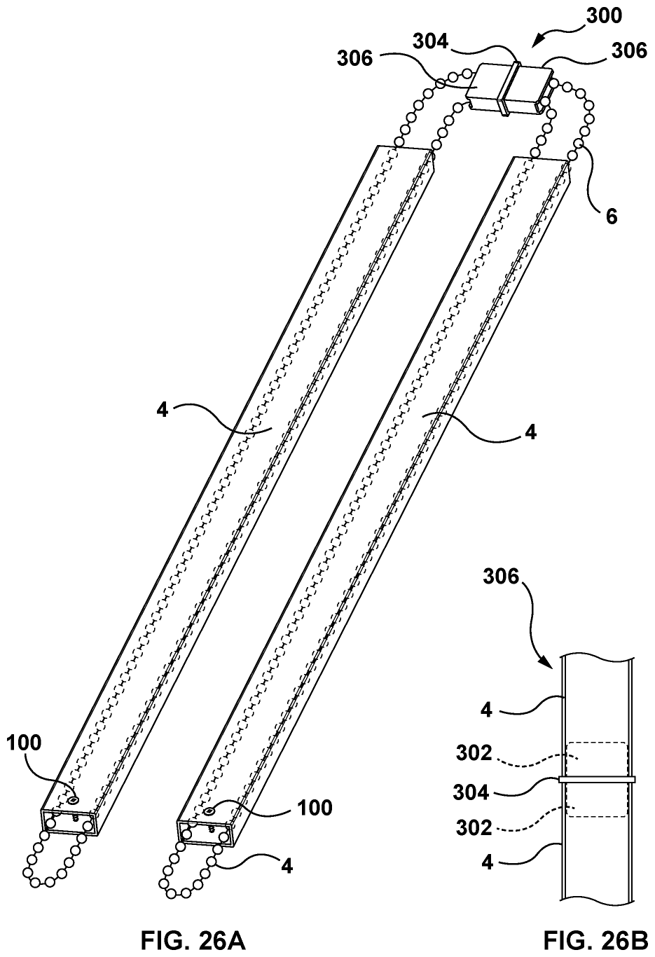

FIGS. 26A and 26B illustrate another embodiment of the invention showing a connector 300 to connect two ends of and elongated member or wand 4. The connector 300 can be used in the event of accommodating a wand 4 which is very long where the wand 4 can be cut into two pieces as shown or be of a convenient length, so as to make it more convenient for shipping. In this case the wand 4 can be cut to convenient lengths where one end of the cut wands 4 can be connected by using a connector 300. The connector 300 can include a shoulder 304 having hollowing connecting ends 306 that are fictionally received by the hollow ends of the wand 4 as shown. The other ends of the two cut wands 4 can include a screw 100 as previously described and the endless loop blind control element 6 is received through the first shortened or cut wand 4, through the connector 306 and through the second cut or shortened wand 4 adapted to be wrapped around a sprocket 12 as previously described.

As previously described each said two pieces of said wand 4 and the connector 306 receive the endless loop blind control element 6 there through when the two pieces of said wand 4 are either connected or disconnected by said connector 306, and the other end of one of said pieces of wand 4 includes a fastener 100 extending through said wand 4 and the other end of the other one of the wand 4 includes an end of the endless loop blind control element 6 adapted to hang from a sprocket 12 or pulley of said blind as previously described.

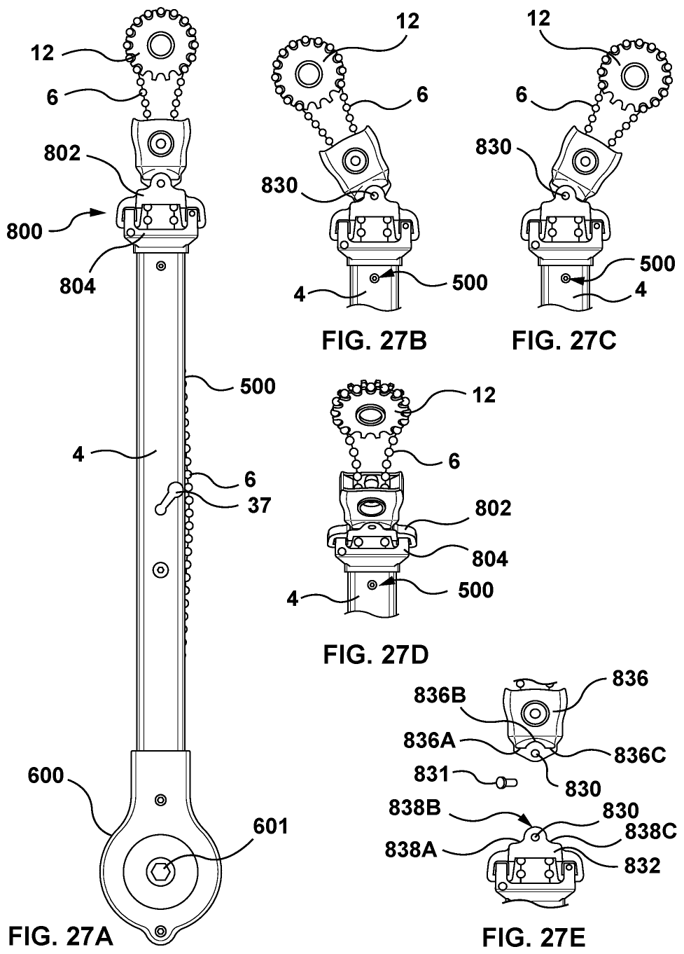

FIG. 27A shows another embodiment of the invention showing a wand 4 having an upper connector housing 800 that can pivot, swivel or move from side to side (see FIGS. 27B and 27C) and front and back (see FIG. 27D), or lay in a substantially vertical resting position. FIG. 27A shows a wand 4 with an endless loop blind control element 6 (which may be a chain) hanging from a sprocket 12 with a cam 37 disposed between the ends of the wand 4 where the cam 37 can be manipulated to push out the chain 6 from the side channels (see FIG. 27A) of the wand 4 to be grasped by a user to move the endless loop blind control element 6 in a first or up direction or a second or down direction. There is a housing 600 at the bottom end of the wand 4 with a hex hole 601 that can receive the crank handle 76 as previously described or the electric motor 67 as previously described.

The upper connector housing 800 includes a first upper part 802 pivoting about the second lower part 804 (see FIG. 27D). The endless loop blind control element 6 can be seen between first upper part and second upper part—but it is inaccessible.

More specifically housing 800 comprises an upper housing portion 836 and a lower housing portion 832 as shown in an exploded view of FIG. 27E. The upper housing portion 836 includes a left upper surface 836A that is capable of bearing against the lower housing portion 838A when the wand is positioned to the left as shown in FIG. 27B. The upper housing portion 836 includes a central upper surface 836B that is capable of bearing against the central lower housing portion 838B when the wand is to the vertical position as shown in FIG. 27A. The upper housing portion 836 includes a right upper surface 836C that is capable of bearing against the right lower housing portion 838C when the wand is in the position shown in FIG. 27C. The wand 4 can be “biased” in these three positions as shown in FIGS. 27A, 27B, and 27C in view of the surfaces described in FIG. 27E.

The upper hosing portion 836 can be connected to lower housing portion 832 by a pin 831 or the like such as a rivet passing through the holes 830.

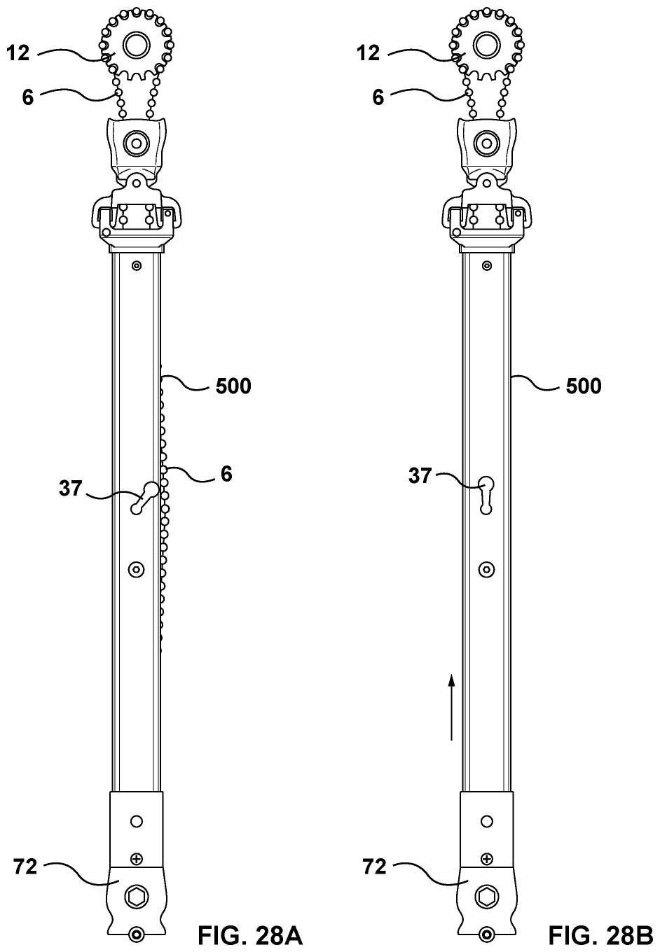

FIGS. 28A and 28B illustrate another embodiment of the invention. FIG. 28A is like FIG. 27A except at the lower end of the wand 4 there is a tensioner 72 like FIG. 23A. FIGS. 28A and 28B show that where the tensioner 72 has been pushed up (i.e. from the lower end toward the upper end to expose the chain 6 once the cam 37 is rotated either to the left or right of the wand 4 to expose the endless loop blind control element from the side channels of the wand 4 to be grasped by a user to move the endless loop blind control element 6 in a first or up direction or a second or down direction.

1. A displaceable wand, comprising; an elongated member extending from an upper end to a lower end, an endless loop blind control element disposed within said elongated member and extends beyond at least one of said upper and lower ends; and a restrictor presented at said lower end, said restrictor extending through said endless loop blind control element to permit said elongated member to:
a) hang from said endless loop blind control element and block access to said one end of said endless loop blind control element in a first position, and;
b) be raised to a second position to expose said one end of said endless loop blind control element and rotate said endless loop blind control element in said second position.

2. The displaceable wand as claimed in claim 1 wherein said restrictor is positioned at said lower end.

3. The displaceable wand as claimed in claim 2 wherein said elongated member comprises a tube.

4. The displaceable wand as claimed in claim 3 wherein said tube is selected from the group having a rectangular, circular, oval, poly-sided and transparent cross section.

5. The displaceable wand as claimed in claim 4 wherein said restrictor is selected from a transverse member extending through said cross-section of said tube.

6. The displaceable wand as claimed in claim 5 wherein said wand includes a first and second spaced side wall and said transverse member comprises a screw extending through said first wall and either touching or extending through the second wall without penetrating the second wall.

7. The displaceable wand as claimed in claim 6 including a plug at said lower end and said screw extending through said first wall, through said plug and either touching or penetrating into the second wall without penetrating through said second wall; said plug disposed at the lower end of said tube, without extending beyond said lower end.

8. The displaceable wand as claimed in claim 4 wherein said restrictor comprises a tensioning device traversed by said endless loop blind control element at said lower end, wherein said tensioning device has an upper end larger than said lower end of said wand and wherein said tensioner is operable to be connected to a widow frame to keep said endless loop blind control element in tension.

9. The displaceable wand as claimed in claim 4 wherein said restrictor comprises a connector capturing said endless loop blind control element at said lower end, wherein said connector is operable to be connected to a widow frame to keep said endless loop blind control element in tension.

10. The displaceable wand as claimed in claim 9 including a tie strap to connect said connector to said endless loop blind control element.

11. The displaceable wand as claimed in claim 8 including a bracket having one side connected to a window frame and another side connected to the tensioning device so as to bias said wand away from a window blind.

12. The displaceable wand as claimed in claim 1 wherein said wand includes a least one magnetic member disposed between said upper and lower ends of said tube; wherein said wand hangs substantially vertical to a window frame and said window frame includes a magnetic metal adjacent said magnetic member for magnetic attraction there between.

13. The displaceable wand as claimed in claim 12 wherein said window frame includes an upper, middle and lower magnetic metal for magnetic attraction to said at least one magnetic member.

14. The displaceable wand as claimed in claim 8 wherein said tensioning device includes a socket opening to engage with a hand crank or electric motor to rotate said endless loop blind control element.

15. The displaceable wand as claimed in claim 1 where up to 8 inches or 20 centimeters of said lower end of said endless loop blind control element is exposed in said second position.

16. The displaceable wand as claimed 12 wherein said tube includes a first magnetic member at said upper end and a second magnetic member at said lower end.

17. A displaceable wand, comprising; an elongated member extending from an upper end to a lower end, an endless loop blind control element disposed exterior to said elongated member and extends beyond at least one of said upper and lower ends; and a restrictor presented at said lower end, and a plurality of spaced fixed stops disposed along the length of the wand.

18. The displaceable wand as claimed in 17 wherein said stops are spaced up to 8 inches or 20 centimeters of each other.

19. The displaceable wand as claimed 18 wherein said stops are fixed to the outside surface of said wand.

20. The displaceable wand as claimed in claim 19 where each said stop comprises two opposite halves connected together.

21. The displaceable wand as claimed in claim 12 further comprising a fastener at the upper end of the wand to secure the wand against a window frame and one magnetic member at the lower end of the wand.

22. The displaceable wand as claimed in claim 21 wherein said fastener comprises a screw having a shoulder bearing against said window frame and said wand includes a hole for said screw wherein said hole includes angled sides.

23. A plurality of spaced stops or collars either:
a) disposed along the length of a wand; or
b) disposed along the length of a frame of a window, where each stop or collar is secured to said wand or frame of a window and includes an endless loop blind control element disposed through each of said stops or collars; and
c) a restrictor at a lower end disposed through the lower end of said endless loop blind control element.

24. The plurality of spaced stops or collars as claimed in claim 23 wherein said plurality of spaced stops or collars are secured around said wand or on one surface of said wand or along said frame of said window.

25. The plurality of said spaced stops as claimed in claim 23 wherein said wand is hollow or solid.

26. The plurality of spaced stops as claimed in claim 25 wherein the wand is solid and said stops or collars are secured around said wand with a lower housing disposed at a lower end of said wand, said housing including a pulley, socket or curved passage to receive a lower end of said endless loop blind control element.

27. The displaceable wand as claimed in claim 3 wherein said wand is in two pieces, further including a connector for connecting an end of each of said two pieces of said wand; wherein each said two pieces of said wand and said connector receive said endless loop blind control element there through when said two pieces of said wand are either connected or disconnected by said connector, and the other end of one of said pieces of wand includes a fattener extending through said wand and the other end of said the other one of said wand includes an end of the endless loop blind control element adapted to hang from a sprocket or pulley of said blind.

28. The displaceable wand as claimed in claim 1 further including an upper connector housing disposed at said upper end that can pivot, swivel or move from side to side and front and back, or lay in a substantially vertical resting position.

29. The displaceable wand as claimed in claim 28 including a tensioner disposed at the lower end of said wand, said tensioner displaceable toward said upper end of said wand.

30. A window blind wand and a fastener wherein the fastener is disposed at:
a) an upper end of the wand to secure the wand against a window frame; or
b) a lower end of the wand to secure the wand against a window frame; or
c) both the upper end of the wand and the lower end of the wand to secure the wand against a window frame; or
d) between the upper end of the wand and lower end of the wand to secure the wand against a window frame.
